(19) United States
(12) Patent Application Publication
(10) Pub. No.: US 2026/0214715 A1
(43) Pub. Date: Jul. 23, 2026

(54) CHANNEL ACCESS METHOD, AND DEVICE AND STORAGE MEDIUM

(71) Applicant: ZTE CORPORATION, Shenzhen (CN)

(72) Inventors: Youxiong LU, Shenzhen (CN); Weimin XING, Shenzhen (CN); Haigang HE, Shenzhen (CN); Jie CHEN, Shenzhen (CN)

(73) Assignee: ZTE CORPORATION, Shenzhen (CN)

(21) Appl. No.: 19/135,010

(22) PCT Filed: Jun. 25, 2024
(86) PCT No.: PCT/CN2024/101141

§ 371 Date: Jun. 2, 2025

(30) Foreign Application Priority Data
Aug. 10, 2023 (CN) 202311014660.0

(51) Int. Cl. H04W 74/0833; H04W 72/02; H04W 72/0446

(52) U.S. Cl. CPC H04W 74/0833; H04W 72/02; H04W 72/0446

(57) ABSTRACT

Provided are a channel access method, a device and a storage medium. The channel access method, which is applied to a first communication device, includes: receiving resource indication information which is indicated by a second communication device and carries at least a CPE selection policy; and determining a CPE start location according to the CPE selection policy.

### TECHNICAL FIELD

The present application relates to the field of communications and, in particular, to a channel access method, a device and a storage medium.

### BACKGROUND

Sidelink communication, such as Long Term Evolution (LTE) sidelink communication and New Radio (NR) sidelink communication, supports two resource allocation methods: a base station scheduling mode (for example, LTE mode 3 and NR mode 1) and a user equipment (UE) autonomous resource selection mode (for example, LTE mode 4 and NR mode 2). In the base station scheduling mode, resources of a base station are allocated by the base station and indicated to a UE; in the UE autonomous resource selection mode, the UE listens to the resource usage in a resource pool and then selects idle resources as the resources for communication.

Additionally, sidelink communication also supports operation in an Intelligent Traffic System (ITS) spectrum, a licensed spectrum, and an unlicensed spectrum. To reduce resource indication overhead, sidelink communication supports using sub-channels as the granularity for frequency-domain resource allocation and indication. The sub-channel is multiple consecutive resource blocks (RBs) in the frequency domain within a resource pool. In the unlicensed spectrum, sidelink communication still uses sub-channels as the frequency-domain resource allocation granularity. However, before an actual signal is sent, channel listening needs to be performed on a channel corresponding to an allocated resource or a selected resource, and only when an idle channel is listened to can the channel be accessed for signal transmission. Methods for channel listening include Type 1, Type 2A/2B/2C, and the like.

If a base station or an access point (AP) operates on an unlicensed carrier, the base station or the AP may listen to a channel, share the obtained channel occupancy time (COT) with other UEs, share the COT obtained by a UE or share the COT obtained by a UE to other UEs so that the resource usage efficiency between UEs can be improved and the channel access type of the UE can be known. However, if the base station or the AP operates in the licensed spectrum or does not operate in the unlicensed spectrum, the base station cannot well control the resource usage and channel access of the UE.

### SUMMARY

In view of the above, embodiments of the present application provide a channel access method, a device and a storage medium to effectively improve resource utilization efficiency and enhance the success rate of a terminal accessing a channel.

An embodiment of the present application provides a channel access method. The channel access method is applied to a first communication device and includes the following operations.

Resource indication information which is indicated by a second communication device and carries at least a cyclic prefix extension (CPE) selection policy is received.

A CPE start location is determined according to the CPE selection policy.

An embodiment of the present application provides a channel access method. The channel access method is applied to a first communication device and includes the following operations.

Resource indication information sent by a second communication device is received.

A CPE start location is selected according to the resource usage of another first communication device and a communication resource indicated by the resource indication information.

An embodiment of the present application provides a channel access method. The channel access method is applied to a second communication device and includes the following operation.

Resource indication information carrying at least a CPE selection policy is indicated to a first communication device to cause the first communication device to determine a CPE start location according to the CPE selection policy.

An embodiment of the present application provides a communication device. The communication device includes a memory and one or more processors.

The memory is configured to store one or more programs.

When the one or more programs are executed by the one or more processors, the one or more processors are caused to perform the method in any one of the preceding embodiments.

An embodiment of the present application provides a storage medium storing a computer program which, when executed by a processor, causes the processor to perform the method in any one of the preceding embodiments.

### BRIEF DESCRIPTION OF DRAWINGS

FIG. 1 is a schematic diagram of the interaction in sidelink communication in the related art;

FIG. 2 is a flowchart of a channel access method according to an embodiment of the present application;

FIG. 3 is a flowchart of another channel access method according to an embodiment of the present application;

FIG. 4 is a flowchart of yet another channel access method according to an embodiment of the present application;

FIG. 5 is a schematic diagram of the configuration of a CPE start location according to an embodiment of the present application;

FIG. 6 is a block diagram of a channel access apparatus according to an embodiment of the present application;

FIG. 7 is a block diagram of another channel access apparatus according to an embodiment of the present application;

FIG. 8 is a block diagram of yet another channel access apparatus according to an embodiment of the present application; and

FIG. 9 is a structural diagram of a communication device according to an embodiment of the present application.

### DETAILED DESCRIPTION

Embodiments of the present application are described hereinafter in conjunction with drawings. The present application is described hereinafter in conjunction with embodiments and the drawings. The examples described hereinafter are intended to explain the present application and not to limit the scope of the present application.

As wireless communication technology has been evolving rapidly by leaps and bounds, the applications across various vertical industries have flourished. To meet the growing and diverse communication demands, UE-to-UE direct communication (also known as sidelink communication) has emerged as a pivotal technology in the fifth-generation (5G) mobile communication systems. This technology is poised to remain a critical communication technology in the ongoing technological enhancement/evolution based on 5G such as 5G-Advanced and even 6G.

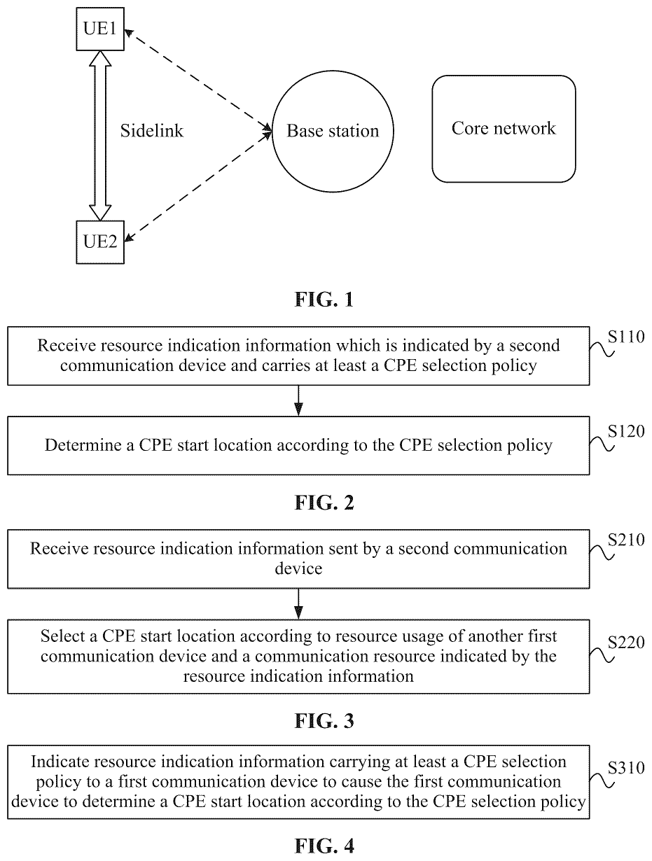

FIG. 1 is a schematic diagram of the interaction in sidelink communication in the related art. As shown in FIG. 1, in a sidelink communication system, when traffic needs to be transmitted between UEs, traffic data between the UEs may be directly sent by the data source UE to the target UE through a sidelink, instead of being forwarded by a network side.

Sidelink communication (for example, device-to-device (D2D) communication, vehicle-to-everything (V2E) communication, and the like) can operate in a variety of scenarios such as scenarios with network coverage, partial network coverage, and no coverage. Sidelink communication also operates in an ITS spectrum and a licensed spectrum and even operates in an unlicensed spectrum in the future. Sidelink communication can reduce the burden of a cellular network, decrease the battery power consumption of the UEs, increase a data rate, and improve the robustness of network infrastructure so that the requirements for traffic with a high data rate and a proximity service are well met. Moreover, sidelink communication also supports the direct communication in scenarios with no network coverage and thus can meet communication demands of the public safety and the Internet of vehicles.

In the sidelink communication system, the UE supports two communication modes: Mode 1, communication based on base station scheduling (referred to as Mode 1 in D2D, Mode 3 in LTE V2X, and Mode 1 in NR V2X); and Mode 2, communication based on UE autonomous resource selection (referred to as Mode 2 in D2D, Mode 4 in LTE V2X, and Mode 2 in NR V2X).

Sidelink communication operates in the unlicensed spectrum. When the UE operates in NR Mode 2, the UE may autonomously select resources and channel access types such as Type 1 and Type 2A/2B/2C. Under different access modes, a CPE may be determined in a variety of manners, but none of them depend on the instruction of the base station. When the UE operates in Mode 1 and assuming that the base station or an AP operates on an unlicensed carrier, the base station or the AP may listen to a channel, share the obtained COT with other UEs, share the COT obtained by the UE or share the COT obtained by the UE to other UEs so that the resource usage efficiency between the UEs can be improved and the channel access types of the UE can be known. However, if the base station or the AP operates in the licensed spectrum or does not operate in the unlicensed spectrum, how to control the resource usage and channel access of the UE is an urgent problem to be solved.

In view of the above, the embodiments of the present application provide a channel access method. In the method, a base station or an AP indicates a CPE selection policy to a UE, which can help UEs to perform frequency-division multiplexing of resources, avoid resource conflicts between the UEs or avoid the access of other UEs being blocked when the UEs contend for access, thereby effectively improving resource utilization efficiency, enhancing the success probability of a UE accessing a channel, and bringing great flexibility and operability to network management.

In an embodiment, FIG. 2 is a flowchart of a channel access method according to an embodiment of the present application. The embodiment is applied to the case of controlling the resource usage and channel access of a terminal when a base station or an AP operates in the licensed spectrum or does not operate in the unlicensed spectrum. The embodiment may be executed by a first communication device. The first communication device may be a UE. As shown in FIG. 2, the embodiment includes S110 and S120.

In S110, resource indication information which is indicated by a second communication device and carries at least a CPE selection policy is received.

In S120, a CPE start location is determined according to the CPE selection policy.

The second communication device sends indicating resource indication information to the first communication device and carries a CPE selection policy in the indicating resource indication information, and the first communication device may determine a CPE start location according to the CPE selection policy and perform channel access according to the CPE start location.

In an embodiment, the CPE selection policy at least includes one of:
using a default CPE start location in a current resource pool;
randomly selecting a CPE start location from an available CPE set in a current resource pool;
selecting a CPE start location corresponding to a current data priority from an available CPE set in a current resource pool;
selecting a CPE start location from an available CPE set corresponding to a current data priority in a current resource pool;
selecting a CPE start location corresponding to a current channel access priority class from an available CPE set in a current resource pool; or
selecting a CPE start location from an available CPE set corresponding to a current channel access priority class in a current resource pool.

In an embodiment, the resource indication information includes at least one of:
physical layer dynamic indication information or higher-layer indication information. The second communication device may dynamically indicate the CPE selection policy to the first communication device through physical layer dynamic indication information, where the physical layer dynamic indication information may include downlink control information (DCI). The second communication device may also semi-statically indicate the CPE selection policy to the first communication device through higher-layer indication information, where the higher-layer indication information may include a radio resource control (RRC) message or a system information block (SIB).

In an embodiment, in the case where the CPE selection policy carried in the resource indication information is invalid, the CPE selection policy is not carried in the resource indication information or the CPE selection policy corresponds to a specific indication value, a corresponding CPE start location is selected according to the resource usage of another first communication device. In the case where the resource indication information sent by the second communication device does not indicate the CPE selection policy, the indicated CPE selection policy is invalid or the CPE selection policy corresponds to a specific indication value, the first communication device may perform select a CPE start location according to the resource usage of another first communication device.

In an embodiment, the operation where the corresponding CPE start location is selected according to the resource usage of another first communication device includes one of the following operations.

In the case where a reserved communication resource of another first communication device and a communication resource indicated by the resource indication information are on the same slot, a default CPE start location is selected.

In the case where the reserved communication resource of another first communication device and the communication resource indicated by the resource indication information are not on the same slot, a CPE start location is selected from a pre-configured CPE start location set.

In an embodiment, the CPE start location set at least includes one of:
an available CPE set in a current resource pool;
an available CPE set corresponding to a current data priority in a current resource pool;
an available CPE set corresponding to a current channel access priority class in a current resource pool;
a CPE start location corresponding to a current data priority in an available CPE set in a current resource pool; or
a CPE start location corresponding to a current channel access priority class in an available CPE set in a current resource pool.

In an embodiment, the resource indication information is further used for indicating a data priority or a channel access priority class on a current granted resource. The data priority of data transmitted on the current granted resource or the channel access priority class corresponding to the current granted resource may be indicated through the resource indication information. The higher the channel access priority class, the shorter the time required to access the channel.

In an embodiment, the CPE selection policy occupies at least one bit in the resource indication information. One bit in the resource indication information may be occupied to indicate the CPE selection policy or at least two bits in the resource indication information may be occupied to indicate the CPE selection policy. For example, in the case where the CPE selection policy is indicated through the physical layer dynamic indication information, the CPE selection policy may be indicated by using one bit to reduce resource occupancy. For example, in the case where the CPE selection policy is indicated through the higher-layer indication information, the CPE selection policy may be indicated by using two bits.

In an embodiment, FIG. 3 is a flowchart of another channel access method according to an embodiment of the present application. The embodiment is applied to the case of controlling the resource usage and channel access of a terminal when a base station or an AP operates in the licensed spectrum or does not operate in the unlicensed spectrum. The embodiment may be executed by a first communication device. In the embodiment, the CPE start location is directly selected by the first communication device. As shown in FIG. 3, the embodiment includes S210 and S220.

In S210, resource indication information sent by a second communication device is received.

In S220, a CPE start location is selected according to the resource usage of another first communication device and a communication resource indicated by the resource indication information.

In the embodiment, the first communication device may directly select the CPE start location according to the resource usage of another first communication device and its own communication resource.

In an embodiment, the operation where the CPE start location is selected according to the resource usage of another first communication device and the communication resource indicated by the resource indication information at least includes one of the following operations.

In the case where a reserved communication resource of another first communication device and the communication resource indicated by the resource indication information are on the same slot and not overlapping, a default CPE start location is selected.

In the case where the reserved communication resource of another first communication device and the communication resource indicated by the resource indication information are on the same slot and overlap and a reference signal received power (RSRP) value of the reserved communication resource of another first communication device is lower than a preset RSRP threshold, a default CPE start location is selected.

In the case where the reserved communication resource of another first communication device and the communication resource indicated by the resource indication information are on the same slot and overlap and the RSRP value of the reserved communication resource is higher than the preset RSRP threshold, a CPE start location is selected from a pre-configured CPE start location set.

In an embodiment, the CPE start location set at least includes one of:
an available CPE set in a current resource pool;
an available CPE set corresponding to a current data priority in a current resource pool;
an available CPE set corresponding to a current channel access priority class in a current resource pool;
a CPE start location corresponding to a current data priority in an available CPE set in a current resource pool; or
a CPE start location corresponding to a current channel access priority class in an available CPE set in a current resource pool.

In an embodiment, FIG. 4 is a flowchart of yet another channel access method according to an embodiment of the present application. The embodiment is applied to the case of controlling the resource usage and channel access of a terminal when a base station or an AP operates in the licensed spectrum or does not operate in the unlicensed spectrum. The embodiment may be executed by a second communication device. As shown in FIG. 4, the embodiment includes S310 and S320.

In S310, resource indication information carrying at least a CPE selection policy is indicated to a first communication device to cause the first communication device to determine a CPE start location according to the CPE selection policy.

In an embodiment, the CPE selection policy at least includes one of:
using a default CPE start location in a current resource pool;
randomly selecting a CPE start location from an available CPE set in a current resource pool;
selecting a CPE start location corresponding to a current data priority from an available CPE set in a current resource pool;
selecting a CPE start location from an available CPE set corresponding to a current data priority in a current resource pool;
selecting a CPE start location corresponding to a current channel access priority class from an available CPE set in a current resource pool; or
selecting a CPE start location from an available CPE set corresponding to a current channel access priority class in a current resource pool.

In an embodiment, the resource indication information includes at least one of: physical layer dynamic indication information or higher-layer indication information.

In an embodiment, the resource indication information is further used for indicating a data priority or a channel access priority class on a current granted resource.

In an embodiment, the CPE selection policy occupies at least one bit in the resource indication information.

It is to be noted that for the explanation of parameters such as the resource indication information and the CPE selection policy mentioned in the channel access method applied to the second communication device, reference may be made to the description of the corresponding parameters in the channel access method applied to the first communication device, and the details are not repeated here.

In the following embodiments, the determination process of the CPE start location is described by using an example in which the first communication device is a UE and the second communication device is a base station.

In an embodiment, the CPE selection policy may be indicated by the base station to the UE to determine the CPE start location. The base station (or an AP) indicates to the UE through current DCI the CPE determination policy for data transmission. The CPE selection policy includes at least one of: using a default CPE start location in a current resource pool; randomly selecting a CPE start location from an available CPE set in a current resource pool; selecting a CPE start location corresponding to a current data priority from an available CPE set in a current resource pool; selecting a CPE start location from an available CPE set corresponding to a current data priority in a current resource pool; selecting a CPE start location corresponding to a current channel access priority class (CAPC) from an available CPE set in a current resource pool; or selecting a CPE start location from an available CPE set corresponding to a current channel access priority class (CAPC) in a current resource pool.

Optionally, the data priority or the channel access priority class (CAPC) may be indicated through the DCI.

Through the preceding method, the following effects can be achieved. If resources are allocated between UEs by using frequency-division multiplexing (FDM), CPE alignment between the UEs can be ensured when the UEs are instructed to employ the same CPE selection policy (for example, using the default CPE start location), thereby avoiding blocking during Listen Before Talk (LBT) operations of the UEs. If the resources allocated between UEs are staggered by using time-division multiplexing (TDM), resource usage conflicts on the same resource can be prevented, and the UEs are instructed to employ different CPE (for example, selecting a CPE start location corresponding to the current data priority from the available CPE set in the current resource pool), the usage of the resources can be staggered, thereby avoiding resource conflicts.

In an embodiment, the operation where the CPE selection policy is indicated by the base station to the UE may be illustrated through the following three examples.

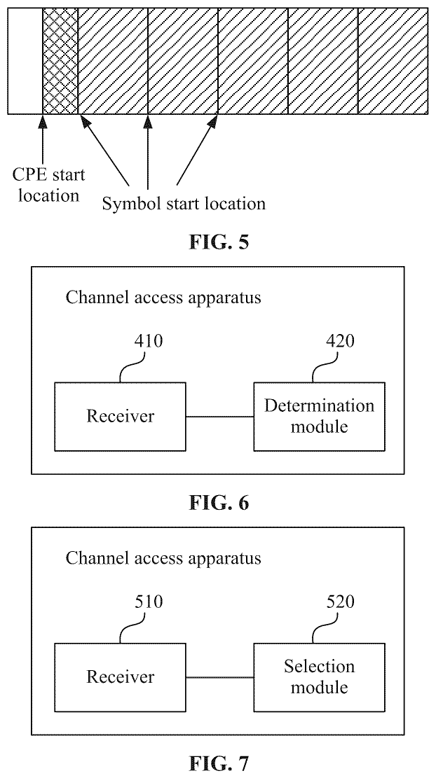

In Example one, the base station (or the AP) indicates the CPE selection policy to the UE through DCI, and the CPE selection policy is indicated by using one bit in the DCI. For example, “1” indicates that the CPE selection policy is to use the default CPE start location in the current resource pool, and “1” indicates that the CPE selection policy is to select a CPE start location from an available CPE set corresponding to a current channel access priority class (CAPC) in the current resource pool. The resources used for sidelink communication are also indicated through the DCI, including resources used by a physical sidelink control channel (PSCCH) and a physical sidelink shared channel (PSSCH), and these resources are located at the sub-channels 1 and 2 in RB set 1 over slot k. When the UE performs PSCCH and PSSCH transmissions over the slot k, the UE determines the CPE start location according to the CPE selection policy indicated by the base station. For example, if the CPE selection policy is indicated as “0”, the default CPE start location in a current resource pool which is indicated through a RRC message or pre-defined is selected, for example, Tsym1+25 ∥s, where Tsym1 represents the start location of the previous symbol of an automatic gain control (AGC) symbol which is the first symbol of the resources used for sidelink communication. For example, if the CPE selection policy is indicated as “1”, a CPE start location is selected from an available CPE set corresponding to a current CAPC in a current resource pool which is indicated through a RRC message or pre-defined. For example, if the available CPE set corresponding to the current CAPC is {T_{sym_1}+16 μs, T_{sym_1}+25 μs, T_{sym_1}+34 μs, T_{sym_1}+43 μs, T_{sym_1}+52 μs, T_{sym_1}+61 μs, T_{sym_0}}, the UE randomly selects a CPE start location, for example, Tsym1+25 μs; if the available CPE set corresponding to the current CAPC is a value, the UE selects the value; where Tsym1 represents the start location of the previous symbol of the AGC symbol which is the first symbol of the resources used for sidelink communication. Illustratively, FIG. 5 is a schematic diagram of the configuration of a CPE start location according to an embodiment of the present application. As shown in FIG. 5, the first symbol of the resources used for sidelink communication may be used as the start location of an AGC symbol, and the CPE start location is then determined based on the start location of the previous symbol of the AGC symbol.

Optionally, the data priority or the CAPC is indicated through the DCI or is indicated through higher-layer indication information of the UE.

In Example two, in addition to the DCI-based indication method, for a semi-static resource indication (configured grant), the CPE determination policy may be indicated through an RRC message.

The base station (or the AP) configures a semi-static resource (configured grant) available for the UE through the RRC message and also indicates a CPE selection policy for data transmission through the RRC message. The CPE selection policy is indicated by using two bits in the RRC message. For example, “0” indicates that the CPE selection policy corresponding to the current resource is to use the default CPE start location in the current resource pool or that the CPE selection policy corresponding to the current resource is to select the first CPE start location from an available CPE set corresponding to a current CAPC in the current resource pool; “1” indicates that the CPE selection policy corresponding to the current resource is to select the second CPE start location from the available CPE set corresponding to the current CAPC in the current resource pool; “2” indicates that the CPE selection policy corresponding to the current resource is to select the third CPE start location from the available CPE set corresponding to the current CAPC in the current resource pool; “3” indicates that the CPE selection policy corresponding to the current resource is to select the fourth CPE start location from the available CPE set corresponding to the current CAPC in the current resource pool.

The semi-static resource (configured grant) includes resources used by a PSCCH and a PSSCH, and these resources are located at the sub-channels 1 and 2 in RB set 1 over slot k. When the UE performs PSCCH and PSSCH transmissions over the slot k, the UE determines the CPE start location according to the CPE selection policy indicated by the base station. For example, if the CPE selection policy is indicated as “0”, the default CPE start location in a current resource pool which is indicated through a RRC message or pre-defined is selected or the CPE selection policy corresponding to the current resource is to select the first CPE start location from the available CPE set corresponding to the current CAPC in the current resource pool, for example, Tsym1+25 μs, where Tsym1 represents the start location of the previous symbol of an AGC symbol which is the first symbol of the resources used for sidelink communication. For example, if the CPE selection policy is indicated as “1”, the second CPE start location is selected from the available CPE set corresponding to the current CAPC in the current resource pool which is indicated through a RRC message or pre-defined. For example, if the available CPE set corresponding to the current CAPC is {T_{sym_1}+16 μs, T_{sym_1}+25 μs, T_{sym_1}+34 μs, T_{sym_1}+43 μs, T_{sym_1}+52 μs, T_{sym_1}+61 μs, T_{sym_0}}, the UE selects the second location, for example, Tsym1+25 μs; if the available CPE set corresponding to the current CAPC is a value, the UE selects the value; where Tsym1 represents the start location of the previous symbol of the AGC symbol which is the first symbol of the resources used for sidelink communication.

Optionally, the data priority or the CAPC is indicated through the RRC message or is indicated through higher-layer indication information of the UE.

In Example three, the CPE determination policy for data transmission, indicated by the base station (or the AP) to the UE through current DCI, is invalid, the base station (or the AP) does not indicate the CPE selection policy or the indicated CPE selection policy is a specific indication value; or the CPE selection policy corresponding to a semi-static resource (configured grant) configured by the base station (or the AP) for the UE through an RRC message is null (invalid), the base station (or the AP) does not indicate the CPE selection policy or the indicated CPE selection policy is a specific indication value.

In the preceding cases, the UE monitors the resource usage of another UE and then selects the CPE start location. If the UE monitors that a resource reserved by another UE and a resource indicated by the UE itself through the DCI or the RRC message are on the same slot, the UE selects a configured or pre-configured default CPE start location; otherwise, the UE randomly selects a CPE start location from a CPE start location set. The CPE start location set includes at least one of:
an available CPE set in a current resource pool;
an available CPE set corresponding to a current data priority in a current resource pool;
an available CPE set corresponding to a current channel access priority class (CAPC) in a current resource pool;
a CPE start location corresponding to a current data priority in an available CPE set in a current resource pool; or
a CPE start location corresponding to a current channel access priority class in an available CPE set in a current resource pool.

In Example four, the CPE determination policy for data transmission, indicated by the base station (or the AP) to the UE through current DCI, is invalid, the base station (or the AP) does not indicate the CPE selection policy or the indicated CPE selection policy is a specific indication value; or the CPE selection policy corresponding to a semi-static resource (configured grant) configured by the base station (or the AP) for the UE through an RRC message is null (invalid), the base station (or the AP) does not indicate the CPE selection policy or the indicated CPE selection policy is a specific indication value.

In the preceding cases, the UE monitors the resource usage of another UE and a channel access type and then selects the CPE start location. If the channel access type is Type 2 or Type 2A/2B/2C, the UE selects a configured or pre-configured default CPE start location. If the channel access type is Type 1, when the UE monitors that a resource reserved by another UE and a resource indicated by the UE itself through the DCI or the RRC message are on the same slot, the UE selects the configured or pre-configured default CPE start location; otherwise, the UE randomly selects a CPE start location from a CPE start location set. The CPE start location set includes at least one of:
an available CPE set in a current resource pool;
an available CPE set corresponding to a current data priority in a current resource pool;
an available CPE set corresponding to a current channel access priority class (CAPC) in a current resource pool;
a CPE start location corresponding to a current data priority in an available CPE set in a current resource pool; or
a CPE start location corresponding to a current channel access priority class in an available CPE set in a current resource pool.

In an embodiment, the operation where the UE receives the CPE selection policy indicated by the base station may be illustrated through the following three examples.

In Example one, the UE receives DCI indicated by the base station (or the AP), and the CPE selection policy for data transmission is indicated through the DCI. The CPE selection policy is indicated by using one bit, where “0” indicates that the CPE selection policy is to use the default CPE start location in the current resource pool, and “1” indicates that the CPE selection policy is to select a CPE start location from an available CPE set corresponding to a current channel access priority class (CAPC) in the current resource pool. The resources used for sidelink communication are also indicated through the DCI, including resources used by a PSCCH and a PSSCH, and these resources are located at the sub-channels 1 and 2 in RB set 1 over slot k. When the UE performs PSCCH and PSSCH transmissions over the slot k, the UE determines the CPE start location according to the CPE determination policy indicated by the base station. For example, if the CPE selection policy is indicated as “0”, the default CPE start location in a current resource pool which is indicated through a RRC message or pre-defined is selected, for example, Tsym1+25 μs, where Tsym1 represents the start location of the previous symbol of an AGC symbol which is the first symbol of the resources used for sidelink communication. For example, if the CPE selection policy is indicated as “1”, a CPE start location is selected from an available CPE set corresponding to a current CAPC in a current resource pool which is indicated through a RRC message or pre-defined. For example, if the available CPE set corresponding to the current CAPC is {T_{sym_1}+16 μs, T_{sym_1}+25 μs, T_{sym_1}+34 μs, T_{sym_1}+43 μs, T_{sym_1}+52 μs, T_{sym_1}+61 μs, T_{sym_0}} , the UE randomly selects a CPE start location, for example, Tsym1+25 μs; if the available CPE set corresponding to the current CAPC is a value, the UE selects the value; where Tsym1 represents the start location of the previous symbol of the AGC symbol which is the first symbol of the resources used for sidelink communication.

After the UE determines the CPE start location according to the CPE selection policy indicated through the DCI, when the UE needs to access a channel, for example, a Type 1 access channel or a Type 2A/2B/2C access channel, the UE attempts channel access based on the determined CPE start location.

Optionally, the data priority or the CAPC is indicated through the DCI or is indicated through higher-layer indication information of the UE.

In Example two, in addition to the DCI-based indication method, for a semi-static resource indication (configured grant), the CPE determination policy may be indicated through an RRC message.

The UE receives the RRC message from the base station (or the AP). A semi-static resource (configured grant) available for the UE is configured in the RRC message, and the CPE determination policy for data transmission is also indicated in the RRC message. The CPE selection policy is indicated by using two bits. “0” indicates that the CPE selection policy corresponding to the current resource is to use the default CPE start location in the current resource pool or that the CPE selection policy corresponding to the current resource is to select the first CPE start location from an available CPE set corresponding to a current CAPC in the current resource pool; “1” indicates that the CPE selection policy corresponding to the current resource is to select the second CPE start location from the available CPE set corresponding to the current CAPC in the current resource pool; “2” indicates that the CPE selection policy corresponding to the current resource is to select the third CPE start location from the available CPE set corresponding to the current CAPC in the current resource pool; “3” indicates that the CPE selection policy corresponding to the current resource is to select the fourth CPE start location from the available CPE set corresponding to the current CAPC in the current resource pool.

The semi-static resource (configured grant) includes resources used by a PSCCH and a PSSCH, and these resources are located at the sub-channels 1 and 2 in RB set 1 over slot k. When the UE performs PSCCH and PSSCH transmissions over the slot k, the UE determines the CPE start location according to the CPE determination policy indicated by the base station. For example, if the CPE selection policy is indicated as “0”, the default CPE start location in a current resource pool which is indicated through a RRC message or pre-defined is selected or the CPE selection policy corresponding to the current resource is to select the first CPE start location from the available CPE set corresponding to the current CAPC in the current resource pool, for example, Tsym1+25 μs, where Tsym1 represents the start location of the previous symbol of an AGC symbol which is the first symbol of the resources used for sidelink communication. For example, if the CPE selection policy is indicated as “1”, the second CPE start location is selected from the available CPE set corresponding to the current CAPC in the current resource pool which is indicated by a RRC message or pre-defined. For example, if the available CPE set corresponding to the current CAPC is {T_{sym_1}+16 μs, T_{sym_1}+25 μs, T_{sym_1}+34 μs, T_{sym_1}+43 μs, T_{sym_1}+52 μs, T_{sym_1}+61 μs, T_{sym_0}}, the UE selects the second location, for example, Tsym1+25 μs; if the available CPE set corresponding to the current CAPC is a value, the UE selects the value; where Tsym1 represents the start location of the previous symbol of the AGC symbol which is the first symbol of the resources used for sidelink communication.

After the UE determines the CPE start location according to the CPE selection policy indicated through the RRC message, when the UE needs to access a channel, for example, a Type 1 access channel or a Type 2A/2B/2C access channel, the UE attempts channel access based on the determined CPE start location.

Optionally, the data priority or the CAPC is indicated through the RRC message or is indicated through higher-layer indication information of the UE.

In Example three, the CPE determination policy for data transmission, indicated by the base station (or the AP) through DCI and received by the UE, is invalid, the base station (or the AP) does not indicate the CPE selection policy or the indicated CPE selection policy is a specific indication value.

Alternatively, the CPE selection policy corresponding to a semi-static resource (configured grant) configured by the base station (or the AP) through an RRC message and received by the UE is null (invalid), the base station (or the AP) does not indicate the CPE selection policy or the indicated CPE selection policy is a specific indication value.

In the preceding cases, the UE monitors the resource usage of another UE and then selects the CPE start location. If the UE monitors that a resource reserved by another UE and a resource indicated by the UE itself through the DCI or the RRC message are on the same slot, the UE selects a configured or pre-configured default CPE start location; otherwise, the UE randomly selects a CPE start location from a CPE start location set. The CPE start location set includes at least one of:
an available CPE set in a current resource pool;
an available CPE set corresponding to a current data priority in a current resource pool;
an available CPE set corresponding to a current channel access priority class (CAPC) in a current resource pool;
a CPE start location corresponding to a current data priority in an available CPE set in a current resource pool; or
a CPE start location corresponding to a current channel access priority class in an available CPE set in a current resource pool.

After the UE determines the CPE start location according to the preceding CPE selection policy, when the UE needs to access a channel, for example, a Type 1 access channel or a Type 2A/2B/2C access channel, the UE attempts channel access based on the determined CPE start location.

In an embodiment, the UE may determine the CPE selection policy based on an RSRP threshold. The UE listens to the resource usage of another UE and then selects the CPE start location. If the UE monitors that a resource reserved by another UE and a resource indicated by the UE itself through DCI or an RRC message, a resource selected by the UE itself or a resource reselected by the UE itself are on the same slot but do not overlap, the UE uses a configured or pre-configured default CPE start location.

If the resource reserved by another UE and the resource indicated by the UE itself through the DCI or the RRC message, the resource selected by the UE itself or the resource reselected by the UE itself are on the same slot and overlap but the RSRP value of the resource reserved by another UE is lower than an RSRP threshold, the UE selects the configured or pre-configured default CPE start location.

Otherwise, the UE randomly selects a CPE start location from a CPE start location set. The CPE start location set includes at least one of:
an available CPE set in a current resource pool;
an available CPE set corresponding to a current data priority in a current resource pool;
an available CPE set corresponding to a current channel access priority class (CAPC) in a current resource pool;
a CPE start location corresponding to a current data priority in an available CPE set in a current resource pool; or
a CPE start location corresponding to a current channel access priority class in an available CPE set in a current resource pool.

After the UE determines the CPE start location according to the preceding CPE selection policy, when the UE needs to access a channel, for example, a Type 1 access channel or a Type 2A/2B/2C access channel, the UE attempts channel access based on the determined CPE start location.

In an embodiment, the UE may determine the CPE selection policy based on an RSRP threshold and a channel access type. If the channel access type is Type 2 or Type 2A/2B/2C, the UE selects a configured or pre-configured default CPE start location. If the channel access type is Type 1, the UE listens to the resource usage of another UE and then selects the CPE start location. If the UE monitors that a resource reserved by another UE and a resource indicated by the UE itself through DCI or an RRC message, a resource selected by the UE itself or a resource reselected by the UE itself are on the same slot but do not overlap, the UE uses the configured or pre-configured default CPE start location.

If the resource reserved by another UE and the resource indicated by the UE itself through the DCI or the RRC message, the resource selected by the UE itself or the resource reselected by the UE itself are on the same slot and overlap but the RSRP value of the resource reserved by another UE is lower than an RSRP threshold, the UE selects the configured or pre-configured default CPE start location.

Otherwise, the UE randomly selects a CPE start location from a CPE start location set. The CPE start location set includes at least one of:
an available CPE set in a current resource pool;
an available CPE set corresponding to a current data priority in a current resource pool;
an available CPE set corresponding to a current channel access priority class (CAPC) in a current resource pool;
a CPE start location corresponding to a current data priority in an available CPE set in a current resource pool; or
a CPE start location corresponding to a current channel access priority class in an available CPE set in a current resource pool.

After the UE determines the CPE start location according to the preceding CPE selection policy, when the UE needs to access a channel, for example, a Type 1 access channel or a Type 2A/2B/2C access channel, the UE attempts channel access based on the determined CPE start location.

In an embodiment, the UE may determine the CPE selection policy based on a channel access type. If the channel access type is Type 2 or Type 2A/2B/2C, the UE selects a configured or pre-configured default CPE start location. If the channel access type is Type 1, the UE listens to the resource usage of another UE and then selects the CPE start location. If the UE monitors that a resource reserved by another UE and a resource indicated by the UE itself through DCI or an RRC message, a resource selected by the UE itself or a resource reselected by the UE itself are on the same slot, the UE uses the configured or pre-configured default CPE start location.

If the resource reserved by another UE and the resource indicated by the UE itself through the DCI or the RRC message, the resource selected by the UE itself or the resource reselected by the UE itself are not on the same slot, the UE randomly selects a CPE start location from a CPE start location set. The CPE start location set includes at least one of:
an available CPE set in a current resource pool;
an available CPE set corresponding to a current data priority in a current resource pool;
an available CPE set corresponding to a current channel access priority class (CAPC) in a current resource pool;
a CPE start location corresponding to a current data priority in an available CPE set in a current resource pool; or
a CPE start location corresponding to a current channel access priority class in an available CPE set in a current resource pool.

After the UE determines the CPE start location according to the preceding CPE selection policy, when the UE needs to access a channel, for example, a Type 1 access channel or a Type 2A/2B/2C access channel, the UE attempts channel access based on the determined CPE start location.

In an embodiment, FIG. 6 is a block diagram of a channel access apparatus according to an embodiment of the present application. The embodiment is applied to a first communication device. As shown in FIG. 6, the channel access apparatus in the embodiment includes a receiver 410 and a determination module 420.

The receiver 410 is configured to receive resource indication information which is indicated by a second communication device and carries at least a CPE selection policy.

The determination module 420 is configured to determine a CPE start location according to the CPE selection policy.

In an embodiment, the CPE selection policy at least includes one of:
using a default CPE start location in a current resource pool;
randomly selecting a CPE start location from an available CPE set in a current resource pool;
selecting a CPE start location corresponding to a current data priority from an available CPE set in a current resource pool;
selecting a CPE start location from an available CPE set corresponding to a current data priority in a current resource pool;
selecting a CPE start location corresponding to a current channel access priority class from an available CPE set in a current resource pool; or
selecting a CPE start location from an available CPE set corresponding to a current channel access priority class in a current resource pool.

In an embodiment, the resource indication information includes at least one of: physical layer dynamic indication information or higher-layer indication information.

In an embodiment, in the case where the CPE selection policy carried in the resource indication information is invalid, the CPE selection policy is not carried in the resource indication information or the CPE selection policy corresponds to a specific indication value, a corresponding CPE start location is selected according to the resource usage of another first communication device.

In an embodiment, the operation where the corresponding CPE start location is selected according to the resource usage of another first communication device includes one of the following operations.

In the case where a reserved communication resource of another first communication device and a communication resource indicated by the resource indication information are on the same slot, a default CPE start location is selected.

In the case where the reserved communication resource of another first communication device and the communication resource indicated by the resource indication information are not on the same slot, a CPE start location is selected from a pre-configured CPE start location set.

In an embodiment, in the case where the CPE selection policy carried in the resource indication information is invalid, the CPE selection policy is not carried in the resource indication information or the CPE selection policy corresponds to a specific indication value, a corresponding CPE start location is selected according to the resource usage of another first communication device and a channel access type, where the channel access type includes one of: Type 1, Type 2, Type 2A, Type 2B or Type 2C.

In an embodiment, the operation where the corresponding CPE start location is selected according to the resource usage of another first communication device and the channel access type includes one of the following operations.

In the case where the channel access type of a current data transmission is Type 1, the CPE start location is selected in one of the following manners.

In the case where a reserved communication resource of another first communication device and a communication resource indicated by the resource indication information are on the same slot, a default CPE start location is selected.

In the case where the reserved communication resource of another first communication device and the communication resource indicated by the resource indication information are not on the same slot, a CPE start location is selected from a pre-configured CPE start location set.

In the case where the channel access type of the current data transmission is Type 2 or Type 2A/2B/2C, the default CPE start location is selected.

In an embodiment, the CPE start location set at least includes one of:
an available CPE set in a current resource pool;
an available CPE set corresponding to a current data priority in a current resource pool;
an available CPE set corresponding to a current channel access priority class in a current resource pool;
a CPE start location corresponding to a current data priority in an available CPE set in a current resource pool; or
a CPE start location corresponding to a current channel access priority class in an available CPE set in a current resource pool.

In an embodiment, the resource indication information is further used for indicating a data priority or a channel access priority class on a current granted resource.

In an embodiment, the resource indication information is further used for indicating a channel access type on a current granted resource, where the channel access type includes one of: Type 1, Type 2, Type 2A, Type 2B or Type 2C.

In an embodiment, the CPE selection policy occupies at least one bit in the resource indication information.

The channel access apparatus provided in the embodiment is configured to perform the channel access method applied to the first communication device according to the embodiment shown in FIG. 2 and has similar implementation principles and effects. The details are not repeated here.

In an embodiment, FIG. 7 is a block diagram of another channel access apparatus according to an embodiment of the present application. The embodiment is applied to a first communication device. As shown in FIG. 7, the channel access apparatus in the embodiment includes a receiver 510 and a selection module 520.

The receiver 510 is configured to receive resource indication information sent by a second communication device.

The selection module 520 is configured to select a CPE start location according to the resource usage of another first communication device and a communication resource indicated by the resource indication information.

In an embodiment, the operation where the CPE start location is selected according to the resource usage of another first communication device and the communication resource indicated by the resource indication information at least includes one of the following operations.

In the case where a reserved communication resource of another first communication device and the communication resource indicated by the resource indication information are on the same slot and do not overlap, a default CPE start location is selected.

In the case where the reserved communication resource of another first communication device and the communication resource indicated by the resource indication information are on the same slot and overlap and an RSRP value of the reserved communication resource of another first communication device is lower than a preset RSRP threshold, the default CPE start location is selected.

In the case where the reserved communication resource of another first communication device and the communication resource indicated by the resource indication information are on the same slot and overlap and the RSRP value of the reserved communication resource is higher than the preset RSRP threshold, a CPE start location is selected from a pre-configured CPE start location set.

In an embodiment, the CPE start location set at least includes one of:
an available CPE set in a current resource pool;
an available CPE set corresponding to a current data priority in a current resource pool;
an available CPE set corresponding to a current channel access priority class in a current resource pool;
a CPE start location corresponding to a current data priority in an available CPE set in a current resource pool; or
a CPE start location corresponding to a current channel access priority class in an available CPE set in a current resource pool.

The channel access apparatus provided in the embodiment is configured to perform the channel access method applied to the first communication device according to the embodiment shown in FIG. 3 and has similar implementation principles and effects. The details are not repeated here.

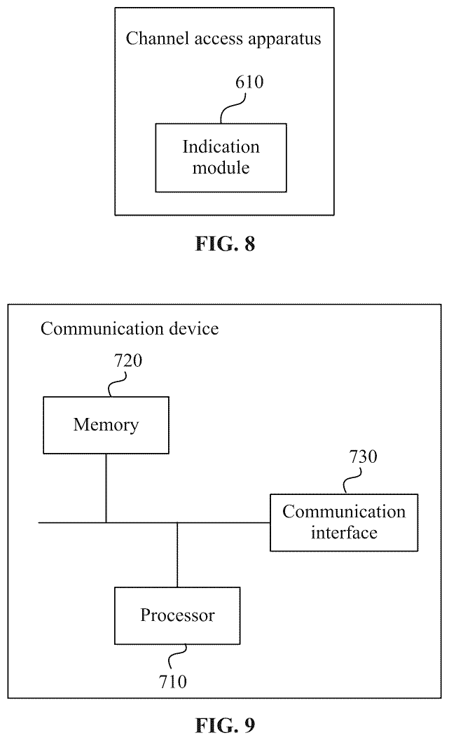

In an embodiment, FIG. 8 is a block diagram of yet another channel access apparatus according to an embodiment of the present application. The embodiment is applied to a second communication device. As shown in FIG. 8, the channel access apparatus in the embodiment includes an indication module 610.

The indication module 610 is configured to indicate resource indication information carrying at least a CPE selection policy to a first communication device to cause the first communication device to determine a CPE start location according to the CPE selection policy.

In an embodiment, the CPE selection policy at least includes one of:
using a default CPE start location in a current resource pool;
randomly selecting a CPE start location from an available CPE set in a current resource pool;
selecting a CPE start location corresponding to a current data priority from an available CPE set in a current resource pool;
selecting a CPE start location from an available CPE set corresponding to a current data priority in a current resource pool;
selecting a CPE start location corresponding to a current channel access priority class from an available CPE set in a current resource pool; or
selecting a CPE start location from an available CPE set corresponding to a current channel access priority class in a current resource pool.

In an embodiment, the resource indication information includes at least one of: physical layer dynamic indication information or higher-layer indication information.

In an embodiment, the resource indication information is further used for indicating a data priority or a channel access priority class on a current granted resource.

In an embodiment, the resource indication information is further used for indicating a channel access type on a current granted resource, where the channel access type includes one of: Type 1, Type 2, Type 2A, Type 2B or Type 2C.

In an embodiment, the CPE selection policy occupies at least one bit in the resource indication information.

The channel access apparatus provided in the embodiment is configured to perform the channel access method applied to the second communication device according to the embodiment shown in FIG. 4 and has similar implementation principles and effects. The details are not repeated here.

In an embodiment, FIG. 9 is a structural diagram of a communication device according to an embodiment of the present application. As shown in FIG. 9, the device provided in the present application includes a processor 710, a memory 720, and a communication interface 730. One or more processors 710 may be provided in the device, and one processor 710 is shown as an example in FIG. 9. One or more memories 720 may be provided in the device, and one memory 720 is shown as an example in FIG. 9. The processor 710, the memory 720, and the communication interface 730 in the device may be connected via a bus or in other manners, and the connection via a bus is shown as an example in FIG. 9. In the embodiment, the device may be a first communication device.

As a computer-readable storage medium, the memory 720 may be configured to store software programs, computer-executable programs, and modules, such as program instructions/modules (for example, the receiver 410 and the determination module 420 in the channel access apparatus) corresponding to the device of any embodiment of the present application. The memory 720 may include a program storage region and a data storage region. The program storage region may store an operating system and an application program required by at least one function. The data storage region may store data created according to the use of the device. Additionally, the memory 720 may include a high-speed random-access memory and may also include a nonvolatile memory such as at least one disk memory, a flash memory, or another nonvolatile solid-state memory. In some examples, the memory 720 may further include memories remotely disposed relative to the processor 710, and these remote memories may be connected to the device via a network. Examples of the preceding network include, but are not limited to, the Internet, an intranet, a local area network, a mobile communication network, and a combination thereof. The communication interface 730 is configured to implement communication interaction among multiple communication devices.

In the case where the communication device is the first communication device, the device may be configured to perform the channel access method applied to the first communication device according to any preceding embodiment and has corresponding functions and effects.

In the case where the communication device is the second communication device, the device may be configured to perform the channel access method applied to the second communication device according to any preceding embodiment and has corresponding functions and effects.

An embodiment of the present application further provides a storage medium. The storage medium stores computer-executable instructions which, when executed by a computer processor, cause the processor to perform a channel access method applied to a first communication device. The method includes: receiving resource indication information which is indicated by a second communication device and carries at least a CPE selection policy, and determining a CPE start location according to the CPE selection policy.

An embodiment of the present application further provides a storage medium. The storage medium stores computer-executable instructions which, when executed by a computer processor, cause the processor to perform a channel access method applied to a first communication device. The method includes: receiving resource indication information sent by a second communication device, and selecting a CPE start location according to the resource usage of another first communication device and a communication resource indicated by the resource indication information.

An embodiment of the present application further provides a storage medium. The storage medium stores computer-executable instructions which, when executed by a computer processor, cause the processor to perform a channel access method applied to a second communication device. The method includes: indicating resource indication information carrying at least a CPE selection policy to a first communication device to cause the first communication device to determine a CPE start location according to the CPE selection policy.

It is to be understood by those skilled in the art that the term “user equipment” encompasses any suitable type of wireless user equipment, for example, a mobile phone, a portable data processing apparatus, a portable web browser, or a vehicle-mounted mobile station.

Generally speaking, embodiments of the present application may be implemented in hardware or special-purpose circuits, software, logic, or any combination thereof. For example, some aspects may be implemented in hardware while other aspects may be implemented in firmware or software executable by a controller, a microprocessor, or another computing apparatus, though the present application is not limited thereto.

Embodiments of the present application may be implemented through the execution of computer program instructions by a data processor of a mobile apparatus, for example, implemented in a processor entity, by hardware, or by a combination of software and hardware. The computer program instructions may be assembly instructions, instruction set architecture (ISA) instructions, machine instructions, machine-related instructions, microcodes, firmware instructions, status setting data, or source or object codes written in any combination of one or more programming languages.

A block diagram of any logic flow among the drawings of the present application may represent program steps, may represent interconnected logic circuits, modules, and functions, or may represent a combination of program steps and logic circuits, modules, and functions. Computer programs may be stored in a memory. The memory may be of any type suitable for a local technical environment and may be implemented using any suitable data storage technology, such as, but not limited to, a read-only memory (ROM), a random-access memory (RAM), or an optical memory device and system (for example, a digital video disc (DVD) or a compact disc (CD)). Computer-readable media may include non-transitory storage media. The data processor may be of any type suitable for the local technical environment, such as, but not limited to, a general-purpose computer, a special-purpose computer, a microprocessor, a digital signal processor (DSP), an application-specific integrated circuit (ASIC), a field-programmable gate array (FPGA), and a processor based on multi-core processor architecture.

The preceding describes preferred embodiments of the present application that are not intended to limit the present application. For those skilled in the art, the present application may have various modifications and variations. Any modifications, equivalent substitutions, improvements, and the like made within the spirit and principle of the present application are within the scope of the present application.

1. A channel access method, applied to a first communication device and comprising:
receiving resource indication information which is indicated by a second communication device and carries at least a cyclic prefix extension (CPE) selection policy; and
determining a CPE start location according to the CPE selection policy.

2. The method of claim 1, wherein the CPE selection policy comprises at least one of:
using a default CPE start location in a current resource pool;
randomly selecting a CPE start location from an available CPE set in a current resource pool;
selecting a CPE start location corresponding to a current data priority from an available CPE set in a current resource pool;
selecting a CPE start location from an available CPE set corresponding to a current data priority in a current resource pool;
selecting a CPE start location corresponding to a current channel access priority class from an available CPE set in a current resource pool; or
selecting a CPE start location from an available CPE set corresponding to a current channel access priority class in a current resource pool.

3. The method of claim 1, wherein the resource indication information comprises at least one of: physical layer dynamic indication information or higher-layer indication information.

4. The method of claim 1, wherein in response to the CPE selection policy carried in the resource indication information being invalid, the CPE selection policy not being carried in the resource indication information or the CPE selection policy corresponding to a specific indication value, a corresponding CPE start location is selected according to resource usage of another first communication device.

5. The method of claim 4, wherein selecting the corresponding CPE start location according to the resource usage of the another first communication device comprises:
in response to a reserved communication resource of the another first communication device and a communication resource indicated by the resource indication information being on a same slot, selecting a default CPE start location; or
in response to a reserved communication resource of the another first communication device and a communication resource indicated by the resource indication information not being on a same slot, selecting a CPE start location from a pre-configured CPE start location set.

6. The method of claim 1, wherein in response to the CPE selection policy carried in the resource indication information being invalid, the CPE selection policy not being carried in the resource indication information or the CPE selection policy corresponding to a specific indication value, a corresponding CPE start location is selected according to resource usage of another first communication device and a channel access type, wherein the channel access type comprises one of: Type 1, Type 2, Type 2A, Type 2B or Type 2C.

7. The method of claim 6, wherein selecting the corresponding CPE start location according to the resource usage of the another first communication device and the channel access type comprises:
in response to a channel access type of a current data transmission being Type 1, selecting the CPE start location in one of the following manners:
in response to a reserved communication resource of the another first communication device and a communication resource indicated by the resource indication information being on a same slot, selecting a default CPE start location; or
in response to a reserved communication resource of the another first communication device and a communication resource indicated by the resource indication information not being on a same slot, selecting a CPE start location from a pre-configured CPE start location set; and
in response to the channel access type of the current data transmission being Type 2 or Type 2A/2B/2C, selecting a default CPE start location.

8. The method of claim 5, wherein the CPE start location set comprises at least one of:
an available CPE set in a current resource pool;
an available CPE set corresponding to a current data priority in a current resource pool;
an available CPE set corresponding to a current channel access priority class in a current resource pool;
a CPE start location corresponding to a current data priority in an available CPE set in a current resource pool; or a CPE start location corresponding to a current channel access priority class in an available CPE set in a current resource pool.

9. The method of claim 1, wherein the resource indication information is further used for indicating a data priority on a current granted resource or a channel access priority class on a current granted resource.

10. The method of claim 1, wherein the resource indication information is further used for indicating a channel access type on a current granted resource, wherein the channel access type comprises one of: Type 1, Type 2, Type 2A, Type 2B or Type 2C.

11. The method of claim 1, wherein the CPE selection policy occupies at least one bit in the resource indication information.

12. A channel access method, applied to a first communication device and comprising:
receiving resource indication information sent by a second communication device; and
selecting a cyclic prefix extension (CPE) start location according to resource usage of another first communication device and a communication resource indicated by the resource indication information.

13. The method of claim 12, wherein selecting the CPE start location according to the resource usage of the another first communication device and the communication resource indicated by the resource indication information comprises at least one of:
in response to a reserved communication resource of the another first communication device and the communication resource indicated by the resource indication information being on a same slot and not overlapping, selecting a default CPE start location;
in response to a reserved communication resource of the another first communication device and the communication resource indicated by the resource indication information being on a same slot and overlapping and a reference signal received power (RSRP) value of the reserved communication resource of the another first communication device being lower than a preset RSRP threshold, selecting a default CPE start location; or
in response to a reserved communication resource of the another first communication device and the communication resource indicated by the resource indication information being on a same slot and overlapping and an RSRP value of the reserved communication resource being higher than a preset RSRP threshold, selecting a CPE start location from a pre-configured CPE start location set.

14. The method of claim 13, wherein the CPE start location set comprises at least one of:
an available CPE set in a current resource pool;
an available CPE set corresponding to a current data priority in a current resource pool;
an available CPE set corresponding to a current channel access priority class in a current resource pool;
a CPE start location corresponding to a current data priority in an available CPE set in a current resource pool; or
a CPE start location corresponding to a current channel access priority class in an available CPE set in a current resource pool.

15. A channel access method, applied to a second communication device and comprising:
indicating resource indication information carrying at least a cyclic prefix extension (CPE) selection policy to a first communication device to cause the first communication device to determine a CPE start location according to the CPE selection policy.

16. The method of claim 15, wherein the CPE selection policy comprises at least one of the following:
using a default CPE start location in a current resource pool;
randomly selecting a CPE start location from an available CPE set in a current resource pool;
selecting a CPE start location corresponding to a current data priority from an available CPE set in a current resource pool;
selecting a CPE start location from an available CPE set corresponding to a current data priority in a current resource pool;
selecting a CPE start location corresponding to a current channel access priority class from an available CPE set in a current resource pool; or
selecting a CPE start location from an available CPE set corresponding to a current channel access priority class in a current resource pool.

17. A communication device, comprising a memory and at least one processor; wherein
the memory is configured to store at least one program; and
when the at least one program is executed by the at least one processor, the at least one processor is caused to perform the method of claim 1.

18. A non-transitory storage medium storing a computer program which, when executed by a processor, causes the processor to perform the method of claim 1.

19. A communication device, comprising a memory and at least one processor; wherein
the memory is configured to store at least one program; and
when the at least one program is executed by the at least one processor, the at least one processor is caused to perform the method of claim 12.

20. A communication device, comprising a memory and at least one processor; wherein
the memory is configured to store at least one program; and
when the at least one program is executed by the at least one processor, the at least one processor is caused to perform the method of claim 15.
